(19) United States
(12) Patent Application Publication
(10) Pub. No.: US 2005/0219806 A1
(43) Pub. Date: Oct. 6, 2005

(54) Meter enclosure cover

(76) Inventor: John Gregory, Halifax (CA)

Correspondence Address: Kenneth McGrail, 6670 Third Street, Halifax, NS, B3L 1G4, CA

(21) Appl. No.: 10/780,064

(22) Filed: Feb. 18, 2004

(51) Int. Cl. G06F 1/16

(52) U.S. Cl. 361/679; D10/75

(57) ABSTRACT

The meter enclosure cover includes a cylindrical tube attached to a cover which allows the face of the meter to be exposed while maintaining the meter at a low profile in the meter enclosure. The cylindrical tube has a flange on one end to provide a surface on which a gasket can be attached. The angle at which the cylindrical tube meets the cover can vary to allow for proper meter viewing as well as protection from water. The flange on the cylindrical tube rests firmly against the circumference of the meter base. All faces of the meter enclosure cover which contact the meter and meter enclosure are sealed by a continuous gasket to protect against dirt, dust, oil and water. The meter enclosure cover is attached to the meter enclosure with a secure locking device. Construction of the meter enclosure cover can be from any appropriate material. Construction methods for the meter enclosure cover include (but are not limited to) cloth lay-up molding, thermoforming, injection molding, as well as cutting and welding/riveting.

This invention is a meter enclosure cover which is used in conjunction with an electrical meter enclosure. The purpose of the meter enclosure cover is to protect the contents of the meter enclosure from tampering, rain, dirt, dust, etc, while allowing the meter to be fully visible at all times. The meter enclosure cover allows access to the meter, while preventing the meter from being removed from its socket.

### DETAILED DESCRIPTION OF THE INVENTION

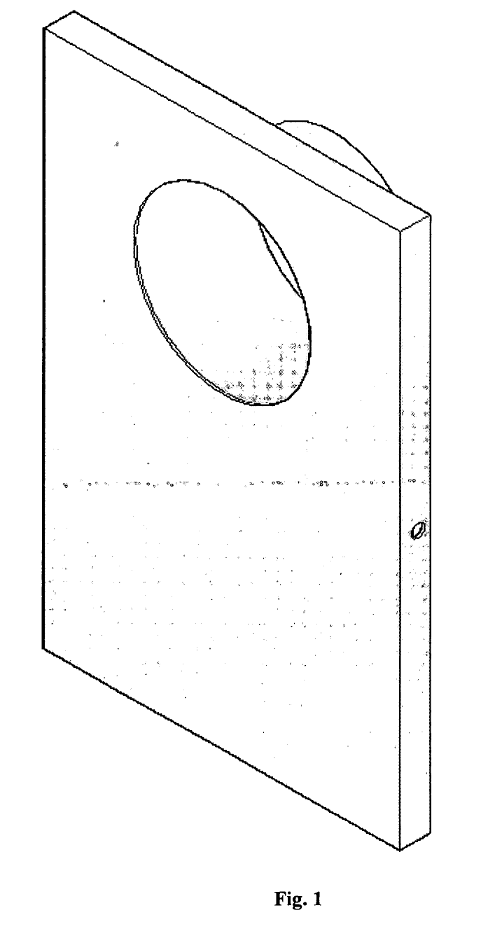

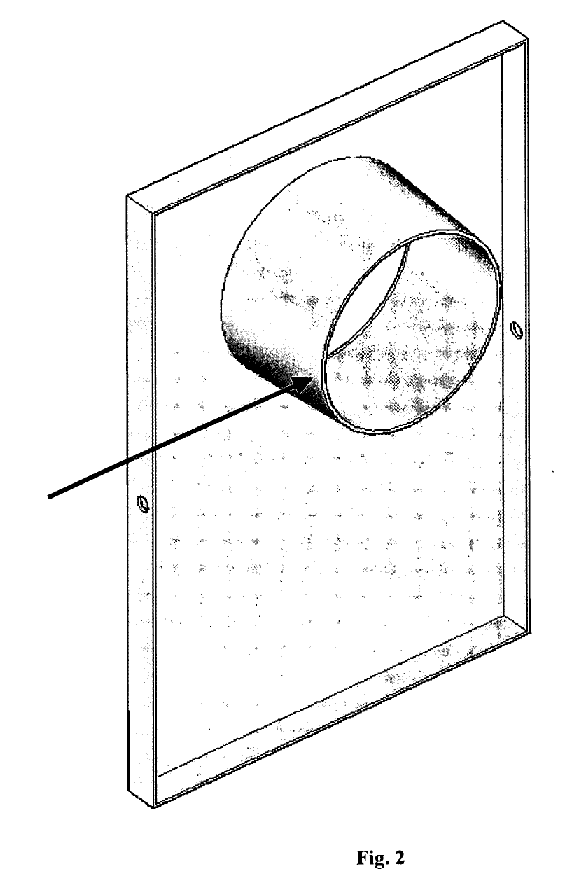

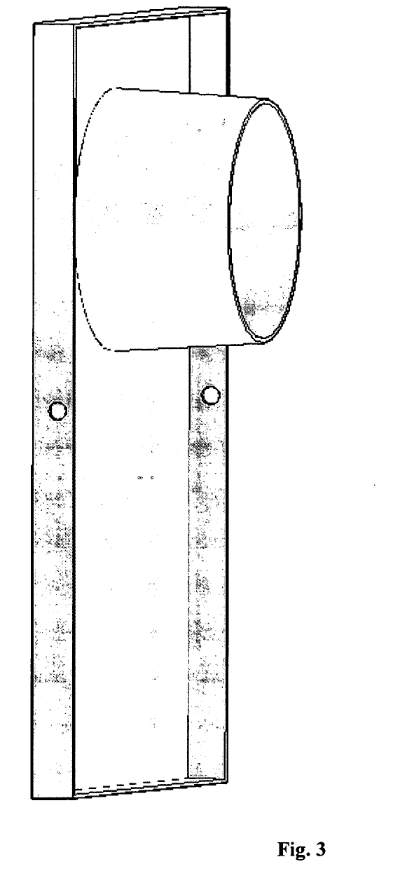

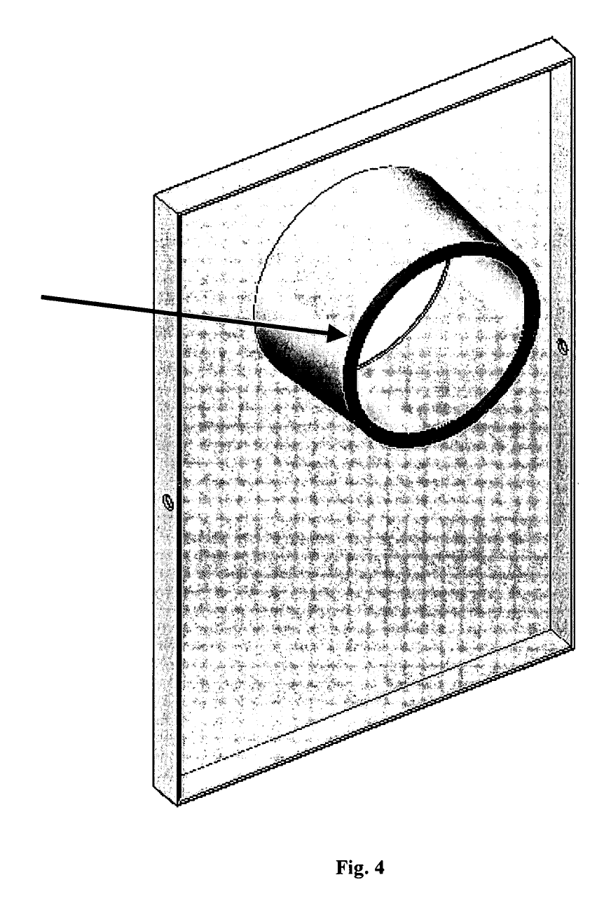

As seen in FIG. 1, the Meter Enclosure Cover consists of a thin rectangular cover with four sidewalls that are small in comparison to the rectangular cover. The sidewalls are fixed to the perimeter of the cover and they are typically more than 1 inch in height. The sidewalls are similar in thickness to the Meter Enclosure Cover. The cover has a hole situated in the middle of the cover, slightly above center. Attached to the back of the cover, in line with the hole in the cover, is a cylindrical object that is similar in thickness to the cover and sidewalls (see FIG. 2) The cylindrical object is open on both ends and tapered slightly; the big end being attached to the circumference of the hole in the cover (See FIG. 3) A gasket material can be attached to the circumference of the small end of the cylindrical object (See FIG. 4).

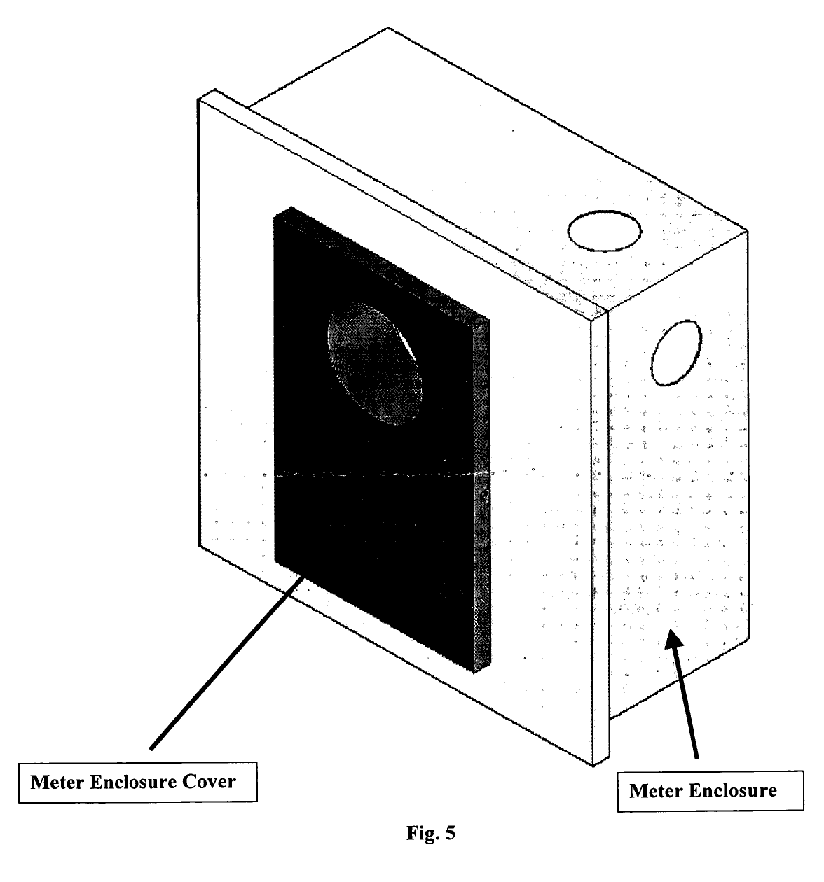

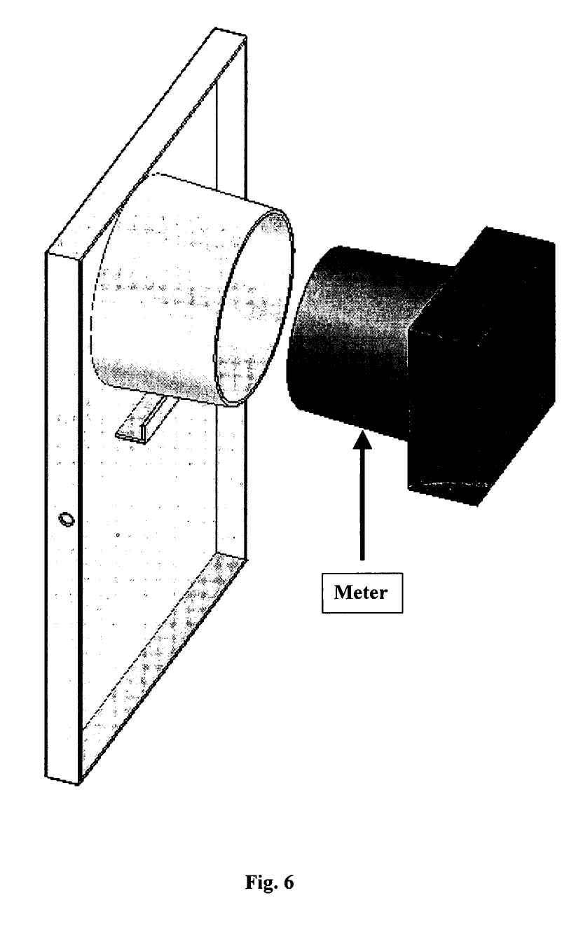

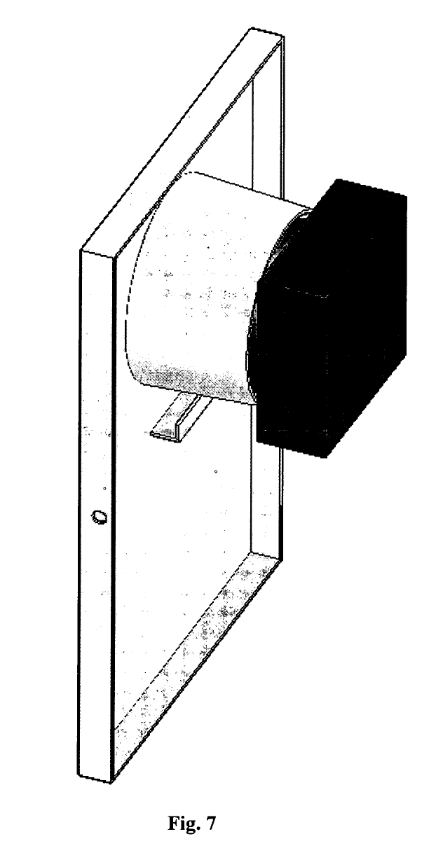

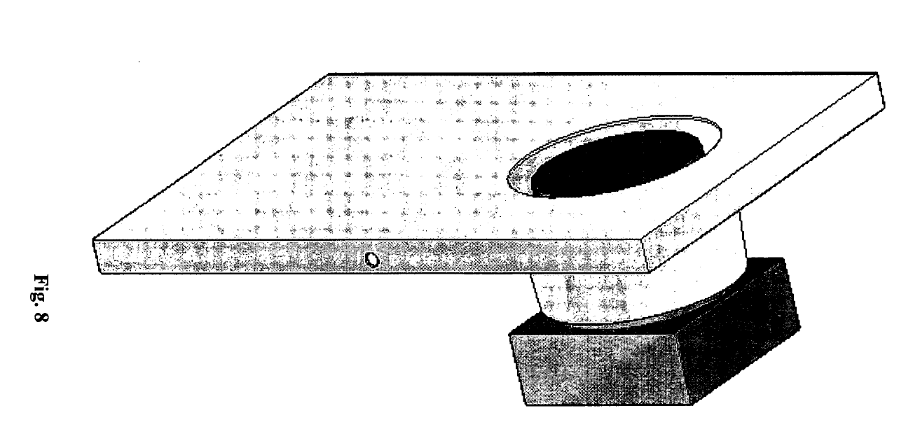

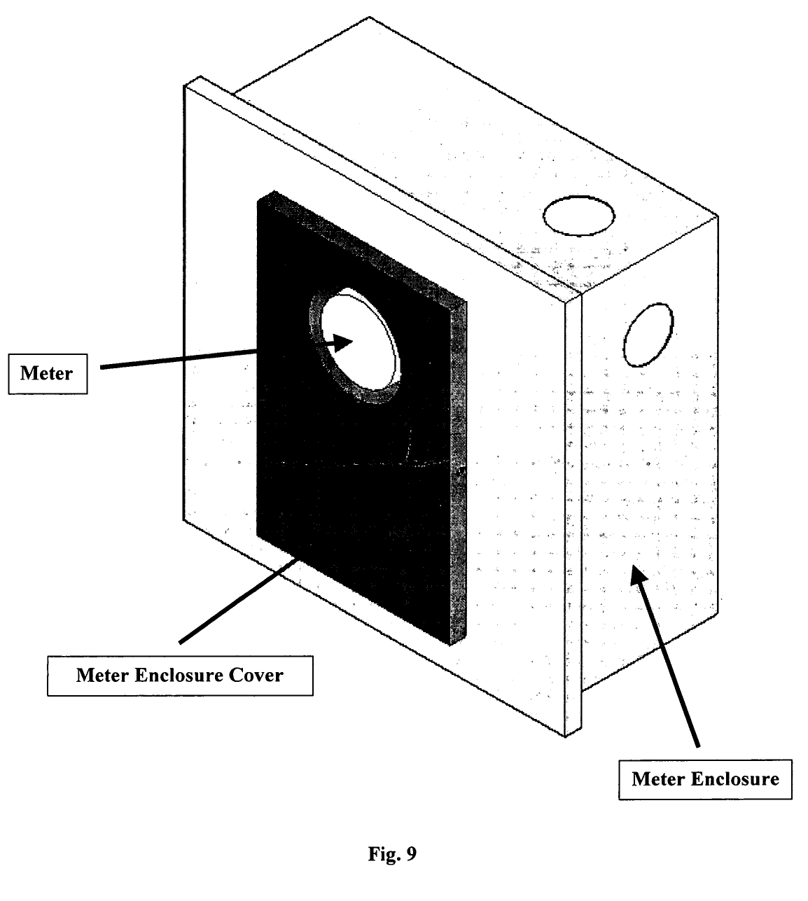

The Meter Enclosure Cover is used to cover one face of a meter enclosure. (See FIG. 5) The meter itself fits into the small end of the cylindrical object on the back of the cover (See FIG. 6). When in place, the cylindrical object allows the face of the meter to be exposed while not allowing the meter to be removed from the meter enclosure without first removing the meter enclosure cover (See FIG. 7 and FIG. 8) In this manner, the meter can be secured in the meter enclosure until the Meter Enclosure Cover is removed. (See FIG. 9).

The Meter Enclosure Cover can be made from Aluminum, Steel, Composites, Polymers or any appropriate material.

1. I claim that the meter enclosure cover protects the contents of the meter enclosure from tampering, rain, dirt, dust, etc, while allowing the meter to be fully visible at all times. The meter enclosure cover allows access to the meter, while preventing the meter from being removed from its socket. The meter enclosure cover allows the face of the meter to be exposed while maintaining the meter at a low profile in the meter enclosure.
